(19) United States
(12) Patent Application Publication
(10) Pub. No.: US 2017/0163545 A1
(43) Pub. Date: Jun. 8, 2017

(54) Traffic Control Method and Apparatus

(71) Applicant: ZTE CORPORATION, Shenzhen City, Guangdong Province (CN)

(72) Inventors: Yunlong JING, Shenzhen (CN); Xiuli ZHANG, Shenzhen (CN)

(21) Appl. No.: 15/321,197

(22) PCT Filed: Sep. 22, 2014
(86) PCT No.: PCT/CN2014/087125

§ 371 Date: Feb. 14, 2017

(30) Foreign Application Priority Data
Jun. 23, 2014 (CN) 201410284595.8

(51) Int. Cl. H04L 12/853; H04L 12/14; H04L 12/859; H04L 12/813; H04L 12/24

(52) U.S. Cl. CPC H04L 47/2416; H04L 47/20; H04L 41/5019; H04L 47/2475; H04L 12/1485; H04L 12/1475; H04L 12/1407

(57) ABSTRACT

The present document discloses a method and apparatus for traffic control. The method includes: receiving a service requirement from a PGW and an Internet-surfing policy corresponding to the service requirement; acquiring traffic control information from an upper-layer application according to the service requirement and the Internet-surfing policy, herein the traffic control information includes: state information of a policy counter to be monitored and a traffic slice corresponding to the state information of the policy counter; and issuing the state information of the policy counter and the traffic slice to the PGW. The technical solution provided by the present document achieves an effect of opening the traffic control to the upper-layer application, saves the unnecessary overhead and investment of a network layer, and improves the capability of a system to quickly deploy a traffic-refined application.

### TECHNICAL FIELD

The present document relates to the field of communications, and particularly to a method and apparatus for traffic control.

### BACKGROUND OF THE RELATED ART

Along with rapid development of the mobile communication technology, the requirement for high bandwidth has been satisfied when users use mobile terminals to surf the Internet. For example, in the 3rd Generation Telecommunication (3G) or the 4th Generation Telecommunication (4G) network, the bandwidth can already reach several megabytes and even hundreds of megabytes. However, a problem caused along with network speed boosting is that: if there is a lack of real-time monitoring mechanism for network traffic, it may be possible that the user uses excessive traffic without totally knowing it and is not informed, thus introducing excessive overhead of mobile communication cost.

In the related art, several following charging modes are usually adopted for the network traffic:

(1) an extensive charging mode;

(2) adopting near-real-time settle accounts to call bills; and

(3) performing real-time monitoring through a Gy interface between an Online Charging System (OCS) and a Gateway GPRS Support Node (GGSN)/a Packet Data Network Gateway (PGW).

However, there is a delay phenomenon by adopting near-real-time settle accounts to call bills, which easily causes use of excessive traffic. The Gy interface is mainly used for real-time charging in the 3rd Generation Partnership Project (3GPP) network architecture, and can partially meet the requirement for traffic control; however, the OCS is only for a part of users but cannot consider all users, and it is defined not for traffic control, so the interface cannot meet the requirements for traffic control of all the users.

For flexible and diverse Internet applications, the existing technical architecture has been unable to meet the requirement for refined control over user traffic of various industries. The concept of traffic service rule control is presented in 3GPP. FIG. 1 is an architecture diagram of executing policy control by adding an Sy interface in 3GPP according to the related art. As shown in FIG. 1, by adding an Sy interface, it can be required that a Policy and Charging Rules Function (PCRF) reports a current policy counter, which acts as a control capability interface of the OCS for service policies (for example, the OCS can choose which service policy is currently used). However, in the above protocol, the Sy interface is only used for policy control, but does not report traffic and perform the traffic control, that is, if the PCRF does not report, the OCS side cannot control policies. At the same time, the PCRF can still adopt a local policy without being determined by the OCS. An upper-layer service does not have control rights either. Thus, the user side still can use the traffic in the network layer, and the situation of excessive traffic usage still exists. In addition, an upper-layer application or an Application Function (AF) entity can control the PCRF through an Rx interface, but it is only used for issuing policies. Thus, there is still a lack of specific traffic control function.

It can be seen from above that, an Sy protocol itself is only used for report real-time policy monitoring, but cannot issue traffic slices and implement monitoring on a service layer such as AF, etc. The Rx interface is only focused on the related control to source and destination used by the user and the Quality of Service (QoS), but cannot achieve a control of service to traffic.

To sum up, a refined control of application to traffic cannot be achieved in the related art. Consequently, at present the existing extensive traffic control cannot be solved radically.

### SUMMARY

The present document provides a method and apparatus for traffic control, for at least solving the problem in the related art that a refined control of application to traffic cannot be achieved.

According to an aspect of the present document, a method for traffic control is provided.

The method for traffic control according to an embodiment of the present document includes: receiving a service requirement from a PGW and an Internet-surfing policy corresponding to the service requirement; acquiring traffic control information from an upper-layer application according to the service requirement and the Internet-surfing policy, herein the traffic control information includes: state information of a policy counter to be monitored and a traffic slice corresponding to the state information of the policy counter; and issuing the state information of the policy counter and the traffic slice to the PGW.

Alternatively, acquiring traffic control information from an upper-layer application according to the service requirement and the Internet-surfing policy includes: sending a Spending-Limit-Request (SLR) message to the upper-layer application according to the service requirement and the Internet-surfing policy; and receiving a Spending-Limit-Answer (SLA) message corresponding to the SLR message from the upper-layer application, herein the SLA message carries the traffic control information.

Alternatively, after issuing the state information of the policy counter and the traffic slice to the PGW, the method further includes: receiving a use result of the traffic slice that is reported by the PGW and a service request for applying for a next traffic slice; and reporting the use result of the traffic slice to the upper-layer application, and acquiring the next traffic slice from the upper-layer application according to the service request.

Alternatively, after issuing the state information of the policy counter and the traffic slice to the PGW, the method further includes: when determining that all traffic slices issued to the PGW are used up and the PGW does not apply for a new traffic slice, reporting a use result of the last traffic slice used by the PGW to the upper-layer application, and sending a Session-Termination-Request (STR) message to the upper-layer application; and receiving a Session-Termination-Answer (STA) message from the upper-layer application, and stopping traffic control to the PGW.

Alternatively, after issuing the state information of the policy counter and the traffic slice to the PGW, the method further includes: receiving a Spending-Status-Notification-Request (SNR) message from the upper-layer application, herein the SNR message is used for indicating adjusting the state information of the policy counter and the traffic slice; notifying the PGW to adjust the state information of the policy counter and the traffic slice; and after determining that the PGW completes adjustment of the state information of the policy counter and the traffic slice, returning a Spending-Status-Notification-Answer (SNA) message to the upper-layer application.

Alternatively, the traffic control information is acquired from the upper-layer application through an extended Sy interface, herein the extended Sy interface includes Usage-Monitoring-Information, and the Usage-Monitoring-Information includes: a Monitoring-Key, which is used for determining the policy counter state information; a Monitoring-Key, which is used for determining the state information of the policy counter; a Granted-Service-Unit, which is used for carrying the traffic slice; a Used-Service-Unit, which is used for reporting the use result of the traffic slice; a Usage-Monitoring-Report, which is used for actively inquiring, by the upper-layer application, the number of used traffic slices; and a Usage-Monitoring-Support, which is used for actively turning off, by the upper-layer application, traffic monitoring.

According to another aspect of the present document, an apparatus for traffic control is provided.

The apparatus for traffic control according to an embodiment of the present document includes: a first receiving module, arranged to receive a service requirement from a PGW and an Internet-surfing policy corresponding to the service requirement; a first acquiring module, arranged to acquire traffic control information from an upper-layer application according to the service requirement and the Internet-surfing policy, herein the traffic control information includes: state information of a policy counter to be monitored and a traffic slice corresponding to the state information of the policy counter; and an issuing module, arranged to issue the state information of the policy counter and the traffic slice to the PGW.

Alternatively, the first acquiring module includes: a sending unit, arranged to send a Spending-Limit-Request (SLR) message to the upper-layer application according to the service requirement and the Internet-surfing policy; and a receiving unit, arranged to receive a Spending-Limit-Answer (SLA) message corresponding to the SLR message from the upper-layer application, herein the SLA message carries the traffic control information.

Alternatively, the apparatus further includes: a second receiving module, arranged to receive a use result of the traffic slice that is reported by the PGW and a service request for applying for a next traffic slice; and a second acquiring module, arranged to report the use result of the traffic slice to the upper-layer application, and acquire the next traffic slice from the upper-layer application according to the service request.

Alternatively, the apparatus further includes: a sending module, arranged to, when determining that all traffic slices issued to the PGW are used up and the PGW does not apply for a new traffic slice, report a use result of the last traffic slice used by the PGW to the upper-layer application, and send a Session-Termination-Request (STR) message to the upper-layer application; and a third receiving module, arranged to receive a Session-Termination-Answer (STA) message from the upper-layer application, and stop traffic control to the PGW.

Alternatively, the apparatus further includes: a fourth receiving module, arranged to receive a Spending-Status-Notification-Request (SNR) message from the upper-layer application, herein the SNR message is used for indicating adjusting the state information of the policy counter and the traffic slice; a notifying module, arranged to notify the PGW to adjust the state information of the policy counter and the traffic slice; and a feedback module, arranged to, after determining that the PGW completes adjustment of the state information of the policy counter and the traffic slice, return a Spending-Status-Notification-Answer (SNA) message to the upper-layer application.

Alternatively, the first acquiring module is arranged to acquire the traffic control information from the upper-layer application through an extended Sy interface, herein the extended Sy interface includes Usage-Monitoring-Information, and the Usage-Monitoring-Information includes: a Monitoring-Key, which is used for determining the state information of the policy counter; a Granted-Service-Unit, which is used for carrying the traffic slice; a Used-Service-Unit, which is used for reporting the use result of the traffic slice; a Usage-Monitoring-Report, which is used for actively inquiring, by the upper-layer application, the number of used traffic slices; and a Usage-Monitoring-Support, which is used for actively turning off, by the upper-layer application, traffic monitoring.

According to the embodiments of the present document, the service requirement from the PGW and the Internet-surfing policy corresponding to the service requirement are received; the traffic control information is acquired from the upper-layer application according to the service requirement and the Internet-surfing policy, herein the traffic control information includes: the state information of the policy counter to be monitored and the traffic slice corresponding to the state information of the policy counter; and the state information of the policy counter and the traffic slice are issued to the PGW. In such a manner, the problem in the related art that a refined control of application to traffic cannot be achieved is solved, the technical progress that a refined control of traffic on an application layer is obtained, an effect of opening the traffic control to the upper-layer application is achieved, the unnecessary overhead and investment of the network layer is saved, and the capability of a system to quickly deploy a traffic-refined application is improved.

### BRIEF DESCRIPTION OF DRAWINGS

The accompanying drawings described here are used for providing a further understanding of the present document, and constitute a part of the present application. Schematic embodiments of the present document and description thereof are used for illustrating the present document but not intended to form an improper limit to the present document. In the accompanying drawings:

FIG. 1 is an architecture diagram of executing policy control by adding an Sy interface in 3GPP according to the related art;

FIG. 2 is a flowchart of a method for traffic control according to an embodiment of the present document;

FIG. 3 is an architecture diagram of executing traffic control by adding an Sy′ interface in 3GPP according to an embodiment of the present document;

FIG. 4 is a structure diagram of an apparatus for traffic control according to an embodiment of the present document; and

FIG. 5 is a structure diagram of an apparatus for traffic control according to an alternative embodiment of the present document.

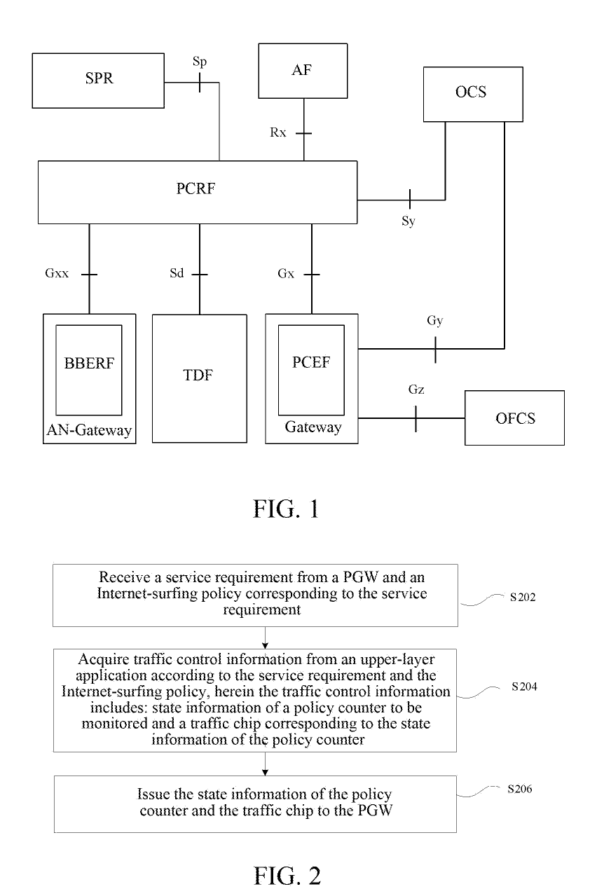

### DETAILED DESCRIPTION

The present document is elaborated below with reference to the accompanying drawings and in combination with the embodiments. It is illustrated that, the embodiments and the features in the embodiments of the present application can be combined with each other under the condition of no conflicts.

FIG. 2 is a flowchart of a method for traffic control according to an embodiment of the present document. As shown in FIG. 2, the method may include the following processing steps.

Step 202: a service requirement from a PGW and an Internet-surfing policy corresponding to the service requirement are received.

Step 204: traffic control information is acquired from an upper-layer application according to the service requirement and the Internet-surfing policy, herein the traffic control information includes: state information of a policy counter to be monitored and a traffic slice corresponding to the state information of the policy counter.

Step 206: the state information of the policy counter and the traffic slice are issued to the PGW.

In the related art, although an Sy interface has been presented in 3GPP, it is mainly used for interactive control of traffic service rules but does not have a related traffic control function; while an Rx interface is mainly used for an AF to control the related bearing of QoS, but not for the traffic control. Thereby, a refined control of application to traffic cannot be achieved in the related art. By using the method as shown in FIG. 2, the state information of the policy counter to be monitored and the traffic slice corresponding to the state information of the policy counter are acquired from the upper-layer application except for the OCS and the OFCS according to the service requirement received from the PGW and the Internet-surfing policy corresponding to the service requirement, and then the acquired state information of the policy counter and the traffic slice are issued to the PGW, so as to implement the requirement for traffic control on an upper-layer service. In such a manner, the problem in the related art that the refined control of application to traffic cannot be achieved is solved, the technical progress that a refined control of traffic on an application layer is obtained, an effect of opening the traffic control to the upper-layer application is achieved, the unnecessary overhead and investment of the network layer is saved, and the capability of a system to quickly deploy a traffic-refined application is improved.

It is illustrated that, in the following alternative embodiments provided by the present document, the extended Sy protocol is called an Sy′ protocol, namely an Sy extended protocol.

In an alternative implementation process, the traffic control information is acquired from the upper-layer application through an extended Sy interface, herein the extended Sy interface may include Usage-Monitoring-Information.

The Usage-Monitoring-Information may include, but is not limited to, the following contents:

(1) a Monitoring-Key, which is used for determining the state information of the policy counter;

(2) a Granted-Service-Unit, which is used for carrying the traffic slice;

(3) a Used-Service-Unit, which is used for reporting a use result of the traffic slice;

(4) a Usage-Monitoring-Report, which is used for actively inquiring, by the upper-layer application, the number of used traffic slices; and

(5) a Usage-Monitoring-Support, which is used for actively turning off, by the upper-layer application, traffic monitoring.

In an alternative embodiment, the extended Sy interface can be added between a PCRF and the upper-layer application, and the requirement for traffic control by the upper-layer service can be implemented through the extended Sy protocol. It is needed to reform the related upper-layer application and the PCRF to support the above extended Sy′ interface protocol and the related logical processing. A related counter is configured at the PCRF side (the counter can be configured according to different service policies, and a package solution is usually adopted). After the user comes online, the PCRF applies for a traffic counter and a corresponding traffic slice through the extended Sy interface. The upper-layer application controls the subsequent issuing of the counter and the corresponding traffic slice according to an internal logic.

Alternatively, in step 204, the acquiring the traffic control information from the upper-layer application according to the service requirement and the Internet-surfing policy may include the following operations.

Step S1: an SLR message is sent to the upper-layer application according to the service requirement and the Internet-surfing policy.

Step S2: an SLA message corresponding to the SLR message is received from the upper-layer application, herein the SLA message carries the traffic control information.

In an alternative embodiment, the user uses a mobile terminal to surf the Internet. The PGW acquires the Internet-surfing policy and services from the PCRF through a Gx interface. The PCRF acquires the traffic control information from the upper-layer service through the Sy′ interface, herein the traffic control information may include, but is not limited to, a counter to be monitored (which is a service that can be carried in a Policy-Counter-Identifier), and adopts the SLR message. The upper-layer service issues the counter to be monitored (Policy-Counter-Statues), and issues the traffic slice (which is carried in an Attribute Value Pair (AVP) of Granted-Service-Unit) at the same time. The PCRF issues a user policy and an available traffic slice to the PGW according to the traffic slice issued by the service and the service requirement.

Alternatively, in step 206, after issuing the state information of the policy counter and the traffic slice to the PGW, the following operations may also be included.

Step S3: a use result of the traffic slice that is reported by the PGW and a service request for applying for a next traffic slice are received.

Step S4: the use result of the traffic slice is reported to the upper-layer application, and the next traffic slice is acquired from the upper-layer application according to the service request.

In an alternative embodiment, the upper-layer application issues the traffic slice, and the PCRF and the PGW of the network side allow the user to use the network traffic according to the above traffic slice. After the traffic slice is used up, the PGW and the PCRF need to apply for the next traffic slice through the Sy interface. Only after the new traffic slice is acquired, the user can continue to use the service normally. That is, after using up the currently issued traffic slice, the PGW reports the use result of traffic; the PCRF reports the result of traffic to the upper-layer application through the Sy′ interface (for example, the result can be reported through a parameter Used-Service-Unit), and then the upper-layer application continues to issue a new traffic slice.

Alternatively, in step 206, after issuing the state information of the policy counter and the traffic slice to the PGW, the following operations may also be included.

Step S5: when it is determined that all traffic slices issued to the PGW are used up and the PGW does not apply for a new traffic slice, a use result of the last traffic slice used by the PGW is reported to the upper-layer application, and an STR message is sent to the upper-layer application.

Step S6: an STA message is received from the upper-layer application, and the traffic control to the PGW is stopped.

In an alternative embodiment, after the user goes offline when ends the use, the PGW reports the last traffic slice, and the PCRF sends a Session-Termination-Request (STR) message to the upper-layer service, so as to represent that the service is offline, simultaneously reports the use result of the last traffic slice to the upper-layer application. The upper-layer application returns a Session-Termination-Answer (STA) message and performs internal settlement.

Alternatively, in step 206, after issuing the state information of the policy counter and the traffic slice to the PGW, the following operations may also be included.

Step S7: an SNR message is received from the upper-layer application, herein the SNR message is used for indicating adjusting the state information of the policy counter and the traffic slice.

Step S8: the PGW is notified to adjust the state information of the policy counter and the traffic slice.

Step S9: an SNA message is returned to the upper-layer application after it is determined that the PGW completes adjustment of the state information of the policy counter and the traffic slice.

In an alternative embodiment, the upper-layer service can adjust the counter and the corresponding traffic slice (through the SNR message) at any time according to its own service features, and the PCRF issues the corresponding control content to the PGW according to the instruction in the above message, so as to indicate the PGW to adjust correspondingly.

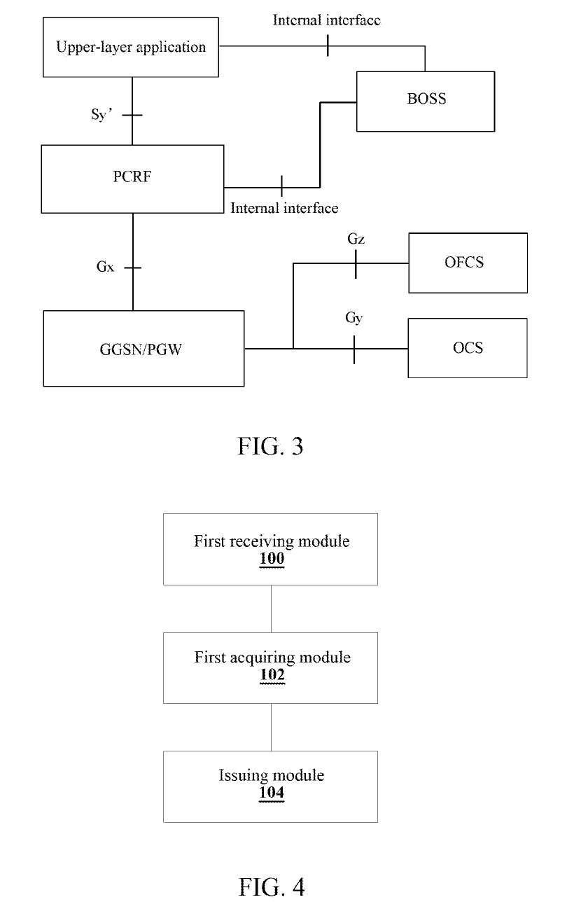

The above alternative implementation processes are further described below in combination with an alternative implementation shown in FIG. 3.

FIG. 3 is an architecture diagram of executing traffic control by adding an Sy′ interface in 3GPP according to an embodiment of the present document. As shown in FIG. 3, the upper-layer can control the PCRF through the Sy′ interface and issue the traffic slice through the PCRF, so that the precise control of the traffic used by the user can be achieved. By extending the Sy′ interface, it is possible that the upper-layer application can have the capability of controlling the traffic used by the user. The protocol extending mode is as follows.

The protocol extension needs to modify the PCRF side and add the extension to the newly-added parameter Usage-Monitoring-Information and the corresponding logical processing. An Attribute Value Pair (AVP) is extended respectively in the Spending-Limit-Request (SLR) message, the Spending-Limit-Answer (SLA) message, the Spending-Status-Notification-Request (SNR) message and the Spending-Status-Notification-Answer (SNA) message in the standard Sy protocol, namely *[Usage-Monitoring-Information]. herein, *[Usage-Monitoring-Information] may include, but is not limited to, the following contents:

Usage-Monitoring-Information::=<AVP Header: 1067>
[Monitoring-Key]
[Granted-Service-Unit]
[Used-Service-Unit]
[Usage-Monitoring-Report]
[Usage-Monitoring-Support]
*[AVP]

It is illustrated that, the above Monitoring-Key is an extended AVP for identifying which counter (a certain policy) is subscribed based on the related definition in the Sy protocol.

The Monitoring-Key can be set to be equal to the Policy-Counter-Identifier.

The Granted-Service-Unit is used for the upper-layer service issuing a quotas slice.

The Used-Service-Unit is used for the PCRF reporting the usage.

The Usage-Monitoring-Report is used for carrying the AVP when the upper-layer service hopes to inquire usage actively.

The Usage-Monitoring-Support is used for carrying the AVP when the upper-layer service hopes to turn off usage monitoring actively, and is set as disabled.

FIG. 4 is a structure diagram of an apparatus for traffic control according to an embodiment of the present document. The apparatus for traffic control can be applied to the PCRF. As shown in FIG. 4, the apparatus for traffic control may include: a first receiving module 100, arranged to receive the service requirement from the PGW and the Internet-surfing policy corresponding to the service requirement; a first acquiring module 102, arranged to acquire the traffic control information from the upper-layer application according to the service requirement and the Internet-surfing policy, herein the traffic control information includes: the state information of the policy counter to be monitored and the traffic slice corresponding to the state information of the policy counter; and an issuing module 104, arranged to issue the state information of the policy counter and the traffic slice to the PGW.

By adopting the apparatus as shown in FIG. 4, the problem in the related art that a refined control of application to traffic cannot be achieved is solved, the technical progress that a refined control of traffic on an application layer is obtained, an effect of opening the traffic control to the upper-layer application is achieved, the unnecessary overhead and investment of the network layer is saved, and the capability of a system to quickly deploy a traffic-refined application is improved.

In an alternative implementation process, the first acquiring module 102 is arranged to acquire the traffic control information from the upper-layer application through the extended Sy interface, herein the extended Sy interface may include Usage-Monitoring-Information.

The Usage-Monitoring-Information may include, but is not limited to, the following contents:

(1) a Monitoring-Key, which is used for determining the state information of the policy counter;

(2) a Granted-Service-Unit, which is used for carrying the traffic slice;

(3) a Used-Service-Unit, which is used for reporting a use result of the traffic slice;

(4) a Usage-Monitoring-Report, which is used for actively inquiring, by the upper-layer application, the number of used traffic slices; and

(5) a Usage-Monitoring-Support, which is used for actively turning off, by the upper-layer application, traffic monitoring.

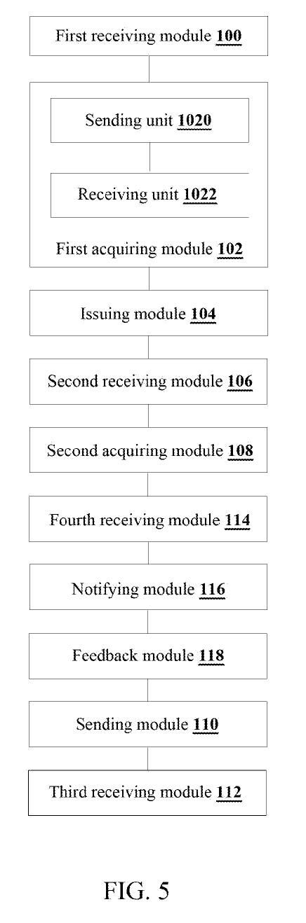

Alternatively, as shown in FIG. 5, the first acquiring module 102 may include: a sending unit 1020, arranged to send the SLR message to the upper-layer application according to the service requirement and the Internet-surfing policy; and a receiving unit 1022, arranged to receive the SLA message corresponding to the SLR message from the upper-layer application, herein the SLA message carries the traffic control information.

Alternatively, as shown in FIG. 5, the apparatus may also include: a second receiving module 106, arranged to receive the use result of the traffic slice that is reported by the PGW and the service request for applying for a next traffic slice; and a second acquiring module 108, arranged to report the use result of the traffic slice to the upper-layer application, and acquire the next traffic slice from the upper-layer application according to the service request.

Alternatively, as shown in FIG. 5, the apparatus may also include: a sending module 110, arranged to, when determining that all traffic slices issued to the PGW are used up and the PGW does not apply for a new traffic slice, report the use result of the last traffic slice used by the PGW to the upper-layer application, and send the STR message to the upper-layer application; and a third receiving module 112, arranged to receive the STA message from the upper-layer application, and stop the traffic control to the PGW.

Alternatively, as shown in FIG. 5, the apparatus may also include: a fourth receiving module, arranged to receive the SNR message from the upper-layer application, herein the SNR message is used for indicating adjusting the state information of the policy counter and the traffic slice; a notifying module 116, arranged to notify the PGW to adjust the state information of the policy counter and the traffic slice; and a feedback module 118, arranged to, after determining that the PGW completes the adjustment of the state information of the policy counter and the traffic slice, return the SNA message to the upper-layer application.

It can be seen from the above description that, the above embodiments achieve the following technical effects (note that, these effects can be achieved by some alternative embodiments): with the technical solution provided by the embodiments of the present document, by extending the Sy interface, the upper-layer application is enabled to obtain a function of directly controlling the traffic used by the user, and thus the flexible Internet applications can obtain the traffic control of user through the above interface (for example, an application of traffic card and the like). Therefore, the technical progress that a refined control of traffic on an application layer is obtained, an effect of opening the traffic control to the upper-layer application is achieved, the unnecessary overhead and investment of the network layer is saved, and the capability of a system to quickly deploy a traffic-refined application is improved.

It will be apparent to those skilled in the art that, they should understand that the above various modules and steps of the present document can be implemented by a general-purpose computing device, and they can be centralized in a single computing device or distributed on a network composed of multiple computing devices. Alternatively, they can be implemented by program codes which can be executable by the computing device, so that they can be stored in a storage device and executed by the computing device. In some situations, the presented or described steps can be executed in an order different from the order described here, or they are made into various integrated circuit modules respectively, or multiple modules and steps of them are made into a single integrated circuit module to realize. In this way, the present document is not limited to any particular combination of hardware and software.

The above is only the alternative embodiments of the present document and not intended to limit the present document. For those skilled in the art, the present document may have various modifications and changes. Any modifications, equivalent replacements, improvements, and the like within the spirit and principle of the present document shall fall within the scope of protection of the present document.

### INDUSTRIAL APPLICABILITY

As abovementioned, a method and apparatus for traffic control provided by the embodiments of the present document have the following beneficial effects: by extending the Sy interface, the upper-layer application is enabled to obtain a function of directly controlling the traffic used by the user, thereby, the technical progress that a refined control of traffic on an application layer is obtained, an effect of opening the traffic control to the upper-layer application is achieved, the unnecessary overhead and investment of the network layer is saved, and the capability of a system to quickly deploy a traffic-refined application is improved.

What is claimed is:

1. A method for traffic control, comprising:
receiving a service requirement from a Packet Data Network Gateway, PGW, and an Internet-surfing policy corresponding to the service requirement;
acquiring traffic control information from an upper-layer application according to the service requirement and the Internet-surfing policy, wherein the traffic control information comprises: state information of a policy counter to be monitored and a traffic slice corresponding to the state information of the policy counter; and
issuing the state information of the policy counter and the traffic slice to the PGW.

2. The method according to claim 1, wherein, acquiring traffic control information from an upper-layer application according to the service requirement and the Internet-surfing policy comprises:
sending a Spending-Limit-Request, SLR, message to the upper-layer application according to the service requirement and the Internet-surfing policy; and
receiving a Spending-Limit-Answer, SLA, message corresponding to the SLR message from the upper-layer application, wherein the SLA message carries the traffic control information.

3. The method according to claim 1, wherein, after issuing the state information of the policy counter and the traffic slice to the PGW, the method further comprises:
receiving a use result of the traffic slice that is reported by the PGW and a service request for applying for a next traffic slice; and
reporting the use result of the traffic slice to the upper-layer application, and acquiring the next traffic slice from the upper-layer application according to the service request.

4. The method according to claim 3, wherein, after issuing the state information of the policy counter and the traffic slice to the PGW, the method further comprises:
when determining that all traffic slices issued to the PGW are used up and the PGW does not apply for a new traffic slice, reporting a use result of the last traffic slice used by the PGW to the upper-layer application, and sending a Session-Termination-Request, STR, message to the upper-layer application; and
receiving a Session-Termination-Answer, STA, message from the upper-layer application, and stopping traffic control to the PGW.

5. The method according to claim 4, wherein, after issuing the state information of the policy counter and the traffic slice to the PGW, the method further comprises:
receiving a Spending-Status-Notification-Request, SNR, message from the upper-layer application, wherein the SNR message is used for indicating adjusting the state information of the policy counter and the traffic slice;
notifying the PGW to adjust the state information of the policy counter and the traffic slice; and
after determining that the PGW completes adjustment of the state information of the policy counter and the traffic slice, returning a Spending-Status-Notification-Answer, SNA, message to the upper-layer application.

6. The method according to claim 1, further comprising: acquiring the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

7. An apparatus for traffic control, comprising:
a first receiving module, arranged to receive a service requirement from a Packet Data Network Gateway, PGW, and an Internet-surfing policy corresponding to the service requirement;
a first acquiring module, arranged to acquire traffic control information from an upper-layer application according to the service requirement and the Internet-surfing policy, wherein the traffic control information comprises: state information of a policy counter to be monitored and a traffic slice corresponding to the state information of the policy counter; and
an issuing module, arranged to issue the state information of the policy counter and the traffic slice to the PGW.

8. The apparatus according to claim 7, wherein, the first acquiring module comprises:
a sending unit, arranged to send a Spending-Limit-Request, SLR, message to the upper-layer application according to the service requirement and the Internet-surfing policy; and
a receiving unit, arranged to receive a Spending-Limit-Answer, SLA, message corresponding to the SLR message from the upper-layer application, wherein the SLA message carries the traffic control information.

9. The apparatus according to claim 7, further comprising:
a second receiving module, arranged to receive a use result of the traffic slice that is reported by the PGW and a service request for applying for a next traffic slice; and
a second acquiring module, arranged to report the use result of the traffic slice to the upper-layer application, and acquire the next traffic slice from the upper-layer application according to the service request.

10. The apparatus according to claim 9, further comprising:
a sending module, arranged to, when determining that all traffic slices issued to the PGW are used up and the PGW does not apply for a new traffic slice, report a use result of the last traffic slice used by the PGW to the upper-layer application, and send a Session-Termination-Request, STR, message to the upper-layer application; and
a third receiving module, arranged to receive a Session-Termination-Answer, STA, message from the upper-layer application, and stop traffic control to the PGW.

11. The apparatus according to claim 10, further comprising:
a fourth receiving module, arranged to receive a Spending-Status-Notification-Request, SNR, message from the upper-layer application, wherein the SNR message is used for indicating adjusting the state information of the policy counter and the traffic slice;
a notifying module, arranged to notify the PGW to adjust the state information of the policy counter and the traffic slice; and
a feedback module, arranged to, after determining that the PGW completes adjustment of the state information of the policy counter and the traffic slice, return a Spending-Status-Notification-Answer, SNA, message to the upper-layer application.

12. The apparatus according to claim 7, wherein, the first acquiring module is arranged to acquire the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

13. The method according to claim 2, further comprising: acquiring the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

14. The method according to claim 3, further comprising: acquiring the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

15. The method according to claim 4, further comprising: acquiring the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

16. The method according to claim 5, further comprising: acquiring the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

17. The apparatus according to claim 8, wherein, the first acquiring module is arranged to acquire the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

18. The apparatus according to claim 9, wherein, the first acquiring module is arranged to acquire the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

19. The apparatus according to claim 10, wherein, the first acquiring module is arranged to acquire the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.

20. The apparatus according to claim 11, wherein, the first acquiring module is arranged to acquire the traffic control information from the upper-layer application through an extended Sy interface, wherein the extended Sy interface comprises Usage-Monitoring-Information, and the Usage-Monitoring-Information comprises:
a Monitoring-Key, which is used for determining the state information of the policy counter;
a Granted-Service-Unit, which is used for carrying the traffic slice;
a Used-Service-Unit, which is used for reporting the use result of the traffic slice;
a Usage-Monitoring-Report, which is used for actively inquiring, by the upper-layer application, the number of used traffic slices; and
a Usage-Monitoring-Support, which is used for actively turning off, by the upper-layer application, traffic monitoring.
